(19) United States
(12) Patent Application Publication
(10) Pub. No.: US 2011/0168037 A1
(43) Pub. Date: Jul. 14, 2011

(54) AUTONOMOUS MODULE BUILDER

(75) Inventors: Stephen W. Searcy, College Station, TX (US); Robert G. Hardin, IV, College Station, TX (US)

(73) Assignee: THE TEXAS A&M UNIVERSITY SYSTEM, College Station, TX (US)

(21) Appl. No.: 12/685,554

(22) Filed: Jan. 11, 2010

(51) Int. Cl. A01D 85/00; B30B 15/16; B30B 15/26

(52) U.S. Cl. 100/35; 100/49; 100/50

(57) ABSTRACT

A system and method for autonomously forming a biomass module, comprising a module builder and a control system. The method comprising autonomous operation the module builder to determine the location of biomass, transmitting data signals indicative of the biomass to the control system, and moving and compressing the biomass according to predetermined algorithms stored in the control system to produce a module.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of the Invention

This invention relates generally to the field of storing harvested biomass prior to processing. More specifically, the invention relates to a method of autonomously constructing cotton modules with minimal loss prior to ginning.

2. Background of the Invention

Maintaining biomass quality prior to processing and during temporary storage near the harvest fields is a serious concern for producers and processors. This is a particular concern for cotton producers. The length of the ginning season has increased, resulting in longer storage times in modules. Serious economic losses can result from moisture damage to seed cotton in modules. If a significant rainfall occurs, the condition of the module cover and the shape of the module determine the degree of quality loss. The economic loss due to a poorly formed seed cotton module has been estimated at over $200/module, regardless of cover quality. Therefore, modules must be built with a shape that prevents the collection of rainwater.

A study of the physical properties of seed cotton concluded that more cotton is preferably placed near the center of the module to produce a convex top surface. Additional tramping of high areas will not significantly affect the module shape. To construct a module properly, the operator must move cotton from areas with more mass into regions with less cotton. Several factors complicate this process. It is difficult for an operator to estimate the mass of cotton in a particular location in the module visually, as certain regions may not have been compressed. The module builder operator may also have difficulty seeing the far end of the module builder. Further, in certain instances, the module builder operator has periods of operation where he is inactive or waiting for the next dump of cotton from the harvesters.

Consequently, there is a need for an autonomous module builder to form water shedding biomass modules.

### BRIEF SUMMARY

An apparatus comprising, a module builder, having a hydraulic system configured for moving a carriage and extending a tramper mounted on the carriage into a hopper for compressing biomass to form a module; a sensor system, having at least one sensor for sensing the tramper; and a control system, configured to operate the module builder autonomously, or without direct human control of all operations.

A method for forming a biomass module comprising: depositing biomass in module builder; activating control system, wherein control system autonomously operates the module builder according to predetermined instructions to form a biomass module.

The method further comprising: extending the tramper into module builder in contact with the biomass; moving the tramper in the module builder to push the biomass; and compressing the biomass to form a module.

### BRIEF DESCRIPTION OF THE DRAWINGS

For a detailed description of the preferred embodiments of the invention, reference will now be made to the accompanying drawings in which:

FIG. 1 illustrates a cross-sectional view of the autonomous module system.

FIG. 2 illustrates a flow chart of data signals within the autonomous module system.

### DETAILED DESCRIPTION OF THE PREFERRED EMBODIMENTS

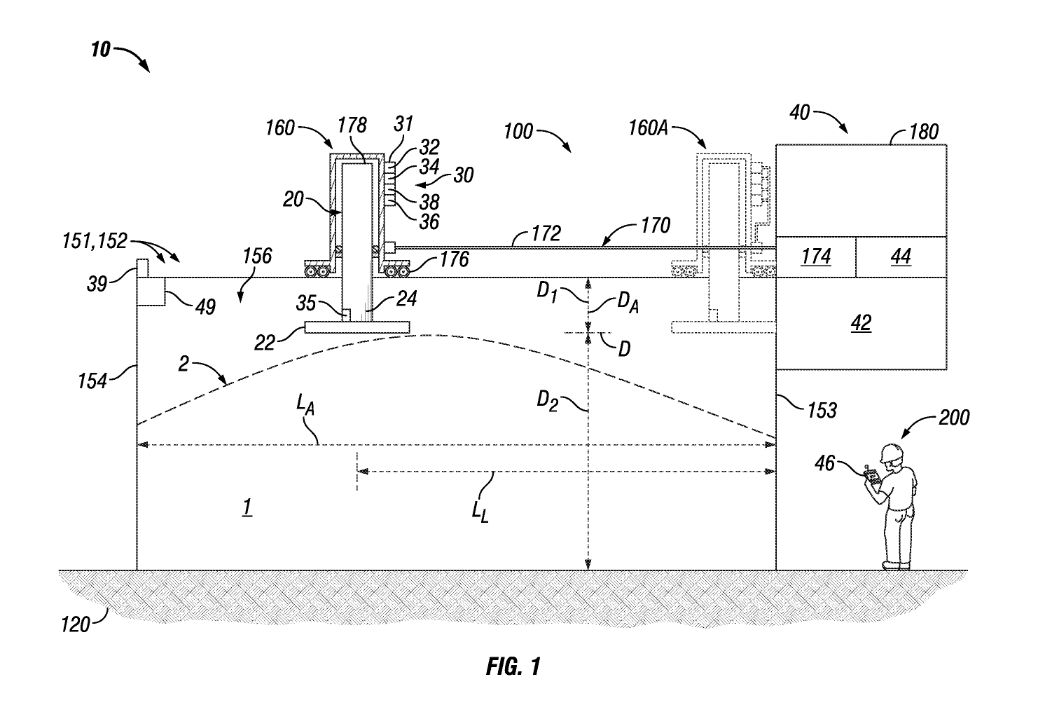

Referring to FIG. 1, the autonomous module system 10 is associated with a module builder 100 for constructing a module 1, without human control. The autonomous module system 100 functions by sensing, analyzing, and altering the operations of a module builder 100 to form module 1. Conventionally, a module 1 is a four-sided stack of compressed biomass, resembling for example a loaf of bread. Module 1 comprises any harvested biomass, for example cotton. A module builder 100 comprises three fixed wall members 151, 152, 153, wherein at least two wall members 151,152 are nearly parallel. The third wall member 153 is the base wall member, and module builder 100 comprises at least one moveable wall member 154. In certain instances, moveable wall member 154 is a door. Wall members 151, 152, 153, 154 form hopper 156.

Module builder 100 further comprises a tramper carriage 160, tramper 20, and hydraulic circuit 170. Hydraulic circuit 170 comprises a hydraulic pump/tank apparatus 174 and other hydraulic components. In instances, other hydraulic components comprise tramper circuit 172, carriage drive 176, and hydraulic piston 178. Optionally, the module builder 100 comprises an operator station 180. The module builder 100 comprises tramper 20, tramper sensor system 30, and control system 40. The tramper 20 comprises tramper foot 22 and ram 24; in instances ram 24 comprises any component of a hydraulic piston system, for instance, a piston or a cylinder. Tramper 20 is disposed on tramper carriage 160. Tramper carriage 160 comprises carriage drive 176 and hydraulic piston 178 configured for extending tramper ram 24 and tramper foot 22 into hopper. Tramper 20 is configured to compress harvested biomass within hopper 156. Tramper 20 is configured for hydraulic extension of ram 24 such that tramper foot 22 contacts and compresses the biomass 1 in hopper 156 against the ground 120. Compression or compaction of biomass 1 forms a module having a module shape 2. The module comprises the biomass, for example seed cotton, deposited in hopper 156. Without limitation by theory, a predetermined module shape comprises any top shape, such as a flat, slanted, domed, peaked, concave or convex module shape 2. In certain instances, is preferable to form a domed shape to facilitate precipitation runoff after a protective covering has been applied and prior to ginning. Without limitation by theory, errors or malformations in the module shape 2 may result in biomass loss.

Autonomous module system 10 comprises tramper sensor system 30, and control system 40 for automatically forming module shape 2. Tramper sensor system 30 comprises vertical sensor 32, longitudinal sensor 34, surface sensor 35, pressure sensor 36, and proximity sensor 38. Tramper sensor system 30 is disposed on the module builder 100, on tramper carriage 160, and in hydraulic circuit 170. Alternatively, tramper sensor system 30 is configurable to be installed on any combination of module builder 100, on tramper carriage 160, in hydraulic circuit 170, any component thereof. Alternately, tramper sensor system 30 is moveably disposed on module builder 100. Control system 40 comprises computer system 42 and input system 44. Control system 40 is disposed in the operator station 180 on module builder 100; alternatively, on tramper carriage 160. Further, control system 40 may be located on any part of module builder 100 without limitation.

Tramper sensor system 30 comprises vertical sensor 32, longitudinal sensor 34, and pressure sensor 36. Tramper sensor system 30 produces data signals indicative of operational coordinates of the autonomous module system 10. Vertical sensor 32 is configured to determine the vertical displacement, or depth D of tramper foot 22 into hopper 156. Longitudinal sensor 34 determines the location L of the tramper carriage 160 along the hopper 156. Pressure sensor 36 determines the pressure of the hydraulic circuit 170 of the autonomous module system 10. Tramper sensor system 30 comprises separate discrete sensors placed at optimized positions on the autonomous module system 10. Alternatively, tramper sensor system 30 comprises coupled sensors or a sensor block 31, configured for operation in determining a plurality of operational coordinates, for example vertical and longitudinal sensing, simultaneously or serially. As such, sensor block 31 may be disposed on any component of the autonomous module system 10, such as base wall 153, operator station 180, or tramper carriage 160, without limitation.

Vertical sensor 32 determines the vertical displacement or depth D of tramper foot 22 into the hopper 156 along depth axis Dₐ. Tramper carriage 160 is configured to carry tramper 20 and support the tramper 20 during the compression stroke of tramper foot 22 into the hopper 156. Vertical sensor 32 determines a distance D₁ between tramper carriage 160 and the tramper foot 22. In certain instances, vertical sensor 32 determines the location of the tramper foot 22 as a distance D₂ from the tramper foot 22 to the ground 120 in hopper 156. The vertical sensor 32 comprises an ultrasonic distance sensor, an optical sensor, such as a laser or spectrometer, or a rotational sensor, such as a rack and pinion, to determine the tramper foot 22 vertical travel into hopper 156. Vertical sensor 32 may be any sensor type or class used to position the tramper 20, either by sensing the actual position of the tramper foot 22 or by sensing movement of any component, such as ram 24, that moves the tramper foot 22 vertically. The vertical sensor 32 is configured for delivering a data signal A to control system 40 indicative of the vertical displacement of the tramper 20.

Tramper carriage 160 is disposed on the top of vertical, parallel walls 151 and 152. Tramper carriage 160 is configured to move along the longitudinal axis Lₐ of the hopper 156. Longitudinal sensor 34 determines location L of the tramper carriage 160 along the hopper 156 and longitudinal axis Lₐ. Longitudinal sensor 34 comprises any sensor device configured for determining a distance between tramper carriage 160 and any preselected point along longitudinal axis Lₐ. In certain instances, longitudinal sensor 34 determines the location of the tramper carriage 160 as a distance L from the base wall member 153 along Lₐ. The longitudinal sensor 34 comprises an ultrasonic distance sensor, an optical sensor such as a laser, or a rotational sensor such as a rack and pinion, to determine the tramper carriage 160 travel along hopper 156. In certain instances, an ultrasonic distance sensor is the vertical sensor 32. Longitudinal sensor 34 may be any sensor type or class used to position the tramper 20 by sensing the actual position of the tramper carriage 160 or by sensing movement of any component that moves the carriage longitudinally. Longitudinal distance sensor 34 comprises a proximity sensor and rotating member, such as a toothed wheel. In certain instances, an ultrasonic distance sensor is the longitudinal distance sensor 34. The longitudinal sensor 160 is configured for delivering a data signal B to control system 40 indicative of the distance L of tramper carriage along longitudinal axis Lₐ.

Surface sensor 35 is disposed on the tramper 20, tramper ram 24, tramper carriage 160, or preferably on the tramper foot 22. Surface sensor 35 is configured to detect the top of biomass 1 during the compression stroke of the tramper 20. Surface sensor 35 is any sensor capable of detecting the top of biomass 1, such as cotton, adjacent to the tramper 20. Surface sensor 35 comprises an optical sensor for example laser, luminescence, spectral, or fiber optic sensor, or an electro-mechanical sensor, such as a strain gauge, piezo-resistive gauge, or the like without limitation. Alternatively, surface sensor 35 is configured to detect the quality, condition, or integrity of biomass 1 in the hopper 156. As tramper foot traverses the width of hopper 156, surface sensor is oriented along longitudinal axis Lₐ. Without limitation by theory, surface sensor 35 detects when the tramper foot 22 is relative to the surface of biomass 1 in the hopper 156. In certain instances, surface sensor 35 detects a change in light, as the uncompressed or partially compressed biomaterial 1 in hopper 156 extends above the tramper foot 22, or otherwise obscures natural light from surface sensor 35. Alternatively, surface sensor 35 detects the reflectance of the deposited biomass 1 for instance by irradiating light from fiber optics and detecting the reflectance of adjacent biomass. In further instances, the surface sensor 35 comprises a whisker or feeler gauge such that the vertical bending of the gauge induces an electric current, signal, or pulse indicative of the top of the biomass 1. Surface sensor 35 is configured to deliver a data signal C to the control system 40 indicative of the top of the biomass 1.

Pressure sensor 36 comprises any sensor configured for determining pressure in hydraulic circuit 170. In certain instances, pressure sensor 36 is configured as a check valve, pressure relief valve, a blow-off valve, or other hydraulic valve. Alternatively, pressure sensor 36 may be absent or replaced with a valve configured to interrupt mechanically or hydraulically the hydraulic circuit 170 in order to discontinue tramper 20 operations at a predetermined pressure threshold. Further, the pressure sensor 36 comprises any device configurable to output a control signal based on hydraulic pressure, such as a sensor, switch, or pressure-controlled valve. Alternatively, pressure sensor 36 may be a component of an electrical or hydraulic system, for instance to determine pressure at the tramper foot 22. Without limitation by theory, a pressure sensor 36 is calibrated to a pre-selected pressure. The pre-selected pressure is a measure of the hydraulic pressure in used to form a module shape 2 having the desired compaction. The pre-selected pressure is indicative of an optimized compression of the biomass 1, for instance cotton. The pre-selected pressure may be indicative of the complete retraction of the tramper foot 22. Further, the pressure sensor 36 is configured delivering a data signal E indicative of the achieving the desired pressure within the hydraulic circuit 170.

Proximity sensor 38 comprises any sensor configured for determining the proximity of a combine, harvester, boll-buggy, or other machinery. In certain instances, proximity sensor 38 comprises sensitivity capable of detecting a human approaching or mounting the autonomous module system 10. Proximity sensor 38 comprises an ultrasonic distance sensor, an optical sensor such as a laser, ultrasonic sensor, a wireless sensor such as infrared or radio sensor. Alternatively, proximity sensor 46 is configured to conduct the same actions of a remote control 46. Proximity sensor 38 is configured to produce and transmit a data signal F indicative of approaching machinery or personnel to the control system 40. Without limitation, proximity sensor 38 is configured as a safety mechanism in order to prevent damage to equipment or the injury to operators and personnel working on or near the module builder 100.

A remote control 46 is configured to transmit a data signal H to the control system 40 directly. The remote 46 is configured to establish and initiate communication between an operator 200 and autonomous module system 10 either directly or indirectly. Alternately, the remote 46 is configured to deliver instructions to control system 40 to begin autonomous operations. Further, the data signal H may comprise instructions to form a module 1 having shape 2, or alternatively to cease operations. Remote 46 data signal H comprises a short range data signal, for instance a short radio signal (e.g. IEEE 802.15.4, ZigBee®, BLUETOOTH®, wi-fi), infra-red, or other signal without limitation. Remote 46 is configured to receive data signal H′ from control system directly. In certain instances, a plurality of remote controls 46 are deployed during autonomous module system 10 operations on a module builder 100.

In certain instances, the autonomous module system comprises a receiver 49. Without limitation by theory, the receiver 49 is configured to receive signals from alternate transmitters. Receiver 49 may be any receiver known in the art, for example a radio, laser, or GPS receiver. The receiver 49 is configured to receive predetermined signals G′ from remote 46 that are not including instructions for operation. Exemplary signals include positional signals, status signals, or maintenance verification signals, without limitation. In certain instance, the signals G′ are two way signals between the remote 46 and the receiver. Signal G′ may be a direct signal to the receiver or alternately, an indirect signal, for instance relayed from a remote operation control center to the autonomous module system 10. Further, receiver 49 may a component of any sensor or component in the autonomous module system 10, for example without limitation, the proximity sensor 38 or the control system 40. Receiver 49 is configurable to passively monitor the status of the sensors, the control system 40, or the hydraulic system 170.

Further, an overflow sensor 39 may be disposed on the module builder 100. The overflow sensor 39 is disposed on at least one member of the module builder 100, for instance on parallel member 151, 152. Alternatively, the overflow sensor 39 comprises a plurality of sensors disposed proximal to the base member 153 and the moveable member 154 along the parallel members 151, 152. Further, the overflow sensor 39 may be disposed on the tramper carriage 160. The overflow sensor 39 is any sensor configured to detect biomass 1 that is accumulated on or adjacent to the upper edge of wall members 151 and 152 and that could potentially be pushed out of the module builder chamber when the carriage 160 is moved laterally on the top of the module builder 100. In instances, the overflow sensor 39 comprises a photoelectric sensor, such a reflectance sensor or other optical sensor an ultrasonic sensor, or a contact sensor. The overflow sensor 39 comprises any sensor configurable to detect biomass 1 on top of the module builder 100, or overflowing the walls or the sides, for instance along parallel members 151, 152, base member 153, and moveable member 154. The overflow sensor 39 is configured to transmit data signal I, indicative of a biomass overflow and the member 151, 152, 153, or 154 that the biomass is overflowing.

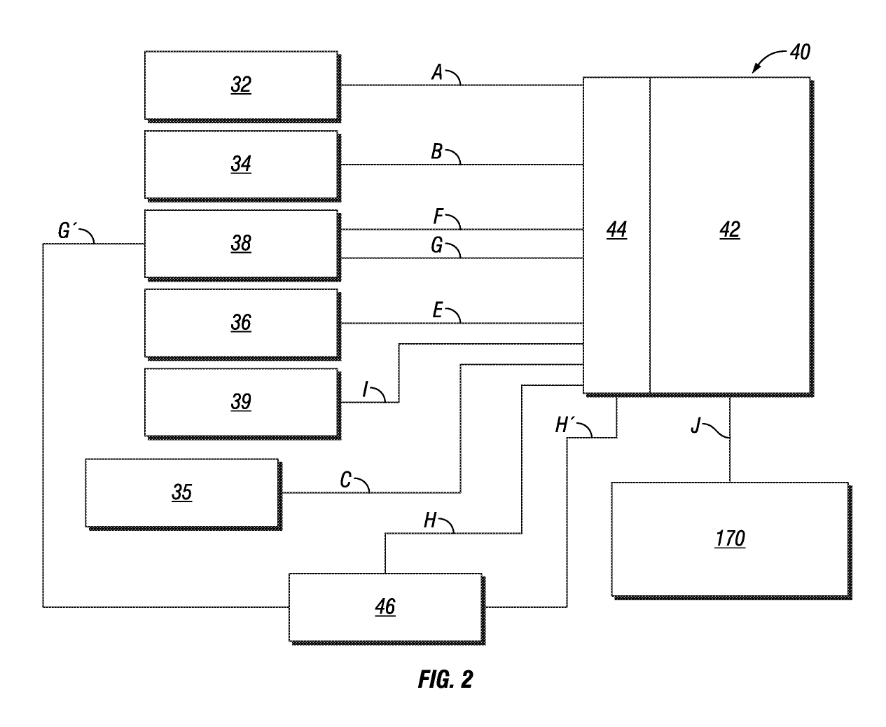

Referring now to FIG. 2, the control system 40 comprises a computer 42 and an input system 44. Control system 40 is disposed on the autonomous tramper system 10, preferably in a weather and dust resistant compartment. In certain instances, control system 40 may be found in an operator station 180 that is at least partially enclosed. Computer 42 is configured as a computer readable medium, containing instructions for the operation of autonomous module system 10. The computer 42 comprises any computer medium capable of storing, modifying, and executing instructions stored thereon. The computer 42 is capable of utilizing multiple data signals A, B, C, E, F, G, H, I, and generating an output data signal J, indicative of operation of the hydraulic system 170, and sending output data signal J to the hydraulic system 170.

An operator 200 comprises a person or persons working in the proximity to the module builder 10 and the autonomous module system 100. Alternatively, the operator 200 comprises an operator of another piece of equipment in the field. In certain instances, the operator 200 is a remote operator, remote communications system, or remote computer system. In instances operator 200 accesses remote control 46 for initiating an autonomous module system 100 operations. Further, operator 200 may comprise a portion of a computer 42 or input system 44, in certain instances a remote computer system. Without limitation by theory, the operator 200 may comprise a remote operations center for controlling the operations of all machinery. In instances, it can be envisioned that the operations of the harvest and module building are conducted without human operators in the field or manually controlling the machinery.

Input system 44 is configured to receive instructions from operator 200 via the remote control console 46 or through inputs directly located on input system 44. Input system 44 is further configured to receive the sensor data signals A, B, C, E, F, G, H, I. In certain instances, data signals A, B, C, E, F, G, H, I are indicative of instructions. Input system 44 coordinates and transfers data signals A, B, C, E, F, G, H, I to computer 42. In certain instances, the input system 44 comprises an operator interface for operator 200 instructions to the computer 42 for the autonomous module system 10. The input system 44 may comprise a manual override, a modifiable computer medium, or other means of altering the algorithm stored on the computer 42, without limitation. Further, input system 44 Input system 44 is further configured to receive instructions to the computer 42 remotely, for instance from remote control 46. Without limitation by theory, input system 44 allows operator 200 to add, change, or remove instructions stored on computer 42. Alternatively, input system 44 receives instructions from a relay or sensor, such as proximity sensor 38 data signal G or remote 46 data signal H. Input system 44 transfers data signals A, B, C, E, F, G, H, I to computer 42. Instructions and data signals A, B, C, E, F, G, H, I obtained by input system 44 are processed by computer 42.

Computer 42 comprises an operator 200 defined module shape 2. Alternatively, computer 42 comprises at least one default or previously defined module shape 2. Computer 42 comprises instructions to act on data signals A, B, C, E, F, G, H, I to move tramper carriage 160, tramper 20, and operate hydraulic system 170 to form module shape 2. Data signal J comprises instructions to hydraulic system 170 to form module shape 2. In certain instances, instructions comprise data, datapoints, data signals, algorithms, or commands that are indicative of operation to form a desired module shape 2 for biomass 1 in hopper 156 as shown in FIG. 1. Without being limited by theory, the module shape 2 is preferably convex along the longitudinal axis Lₐ in order to increase water shedding and decrease precipitation retention on the top of biomass 1. In instances, an operator 200 instructs the autonomous module system 10 to complete a module by completing a sequence of motions of carriage 160 and tramper foot 22 to form module shape 2. Without limitation by theory this instruction, plus any other alternative instructions that could be initiated by an operator 200 are submitted to the control system 40 via remote control 46 or input system 44. The computer 42 processes the operator 200 instructions via remote control 46 data signal G′ or data signal H.

During operation, the computer 42 contains instructions to return tramper carriage 160 to a safe or default location 160A. Without limitation by theory, a default location 160A is a storage location for tramper carriage 160 that does not interfere with access to hopper 156. In certain instances, default location 160A positions tramper carriage 160 at or above the base member 153. The default location 160A is at one end of the longitudinal axis Lₐ. Default location 160A provides access to the hopper 156 for the deposition of biomaterial 1, for example, boll buggy dumping of seed cotton. Further default location 160A provides for maintenance, repair, or transport of autonomous module system 10. To form module shape 2, the operator 200 instructs tramper carriage 160 to move to default location 160A, in preparation for dumping biomaterial 1 into hopper 156. Data signal J comprises instructions to hydraulic system 170 for moving tramper carrier 160 to default location 160A.

Computer 42 controls hydraulic system 170 for autonomous forming of module shape 2. After deposition of biomaterial 1 into the hopper 156, the tramper carriage 160 carries tramper 20 along the longitudinal axis Lₐ of the hopper 156. Longitudinal sensor 34 senses the longitudinal movement, or location L of tramper carriage 160 and sends data signal B indicative of the longitudinal position along longitudinal axis Lₐ.

The tramper carriage 160 stops at predetermined intervals or locations L, along the longitudinal axis Lₐ and extends the tramper foot 22 in contact with the biomaterial 1 in the hopper 156. Computer 42 controls hydraulic system 170 for extending tramper foot 22 vertically into hopper 156. Tramper foot 22 extends vertically into hopper 156 to compress biomass disposed therein. Vertical sensor 32 senses the extension of tramper ram 24 and the depth D of tramper foot 24. Vertical sensor sends data signal A to input system 44 and computer 42. Data signal A is indicative of the vertical position of the tramper foot 22. Data signal A and data signal B are indicative of the tramper foot 22 coordinate L, D for computer 42. In certain instances, data signal A and data signal B are indicative of the volume of biomass 1 in the hopper 156.

Tramper ram 24 is extended hydraulically to compress biomass 1 in hopper 156. Extension of tramper ram 24, causing tramper foot 22 to come in contact with biomass 1, increases pressure in hydraulic system 170 as the biomass 1 is compressed beneath tramper foot 22. Pressure sensor 36 detects pressure and transmits data signal E, indicative of the pressure to computer 42. Without limitation by theory, the pressure and vertical displacement of the tramper are indicative of the quantity or mass of the biomass 1 under tramper foot 22. Further, surface sensor 35 disposed on tramper foot 22, tramper ram 24, or tramper carriage 160, detects the top, or surface of the biomass 1. Surface sensor 35 detects the quality, condition, and integrity of the biomass 1. Surface sensor 35 transmits data signal C comprising data components indicative of surface and quality, condition, and integrity of the biomass 1, to computer 42.

In certain instances, as data signal E determines the pressure of in the hydraulic system, it partially indicates the mass of biomass at a given tramper foot 22 coordinate L, D for computer 42. Data signal C comprises a data component correlated to the biomass surface 2 or depth D at a given tramper foot 22 coordinate L, D for computer 42. In certain instances, data signal C comprises a data component indicative of the quality, condition, or integrity of the biomass 1. Computer 42 receives the coordinate L, D of tramper foot 22, for comparison with other data signals, for example data signal A and data signal E indicative of the longitudinal position and pressure respectively. During operation, computer 42 compares the tramper foot 22 coordinate L, D, indicated by data signal B and data signal A respectively, with the operator 200 determined module shape 2. In certain instances, computer 42 determines biomass 1 mass and volume, indicated by data signal E and data signal C respectively. In further instances, the data signal A, B, C and E are used to predict and compare biomass surface 2 with the operator 200 determined module shape 2.

Computer 42 determines mass and volume distribution of biomass 1 along longitudinal axis Lₐ in hopper 156. Computer 42 compares distribution of biomass 1 against stored or operator determined module shape 2. Computer 42 transmits data signals J to hydraulic system 170 indicative of tramper 20 movements. Data signals J comprise instructions for tramper 20 to move, or push biomass 1 longitudinally along longitudinal axis Lₐ. Tramper 20 instructions from computer 42 comprise depth D to extended tramper ram 24 and foot 22. Tramper 20 instructions in data signal J comprises longitudinal movement of tramper carriage 160. Without limitation by theory, moving tramper carriage 160 along longitudinal axis Lₐ, with tramper ram 24 and tramper foot 22 extended into biomass 1, moves biomass 1. As such, computer 42 controls the redistribution of biomass 1 along longitudinal axis Lₐ to form module shape 2, as stored on computer 42. In certain instances, data signals J comprise a step-up or step-down instruction for altering tramper 20 depth D vertically during the process of pushing. In certain instances, the pressure sensor 36 provides data signal E to the computer 42 indicating that the tramper foot 22 requires instructions J to be raised. Alternatively, the surface sensor 35 provides computer 42 data signal C indicative that the tramper foot 22 is above the biomass 1 in hopper 156. Altering the depth D of the tramper 20 change the quantity of biomass 1 moved along longitudinal axis Lₐ. The data signals J further comprise instructions to move biomass 1 towards the ends of the hopper 156, for example, moveable member 154 or the base member 153. Alternatively, the data signal J comprises instructions to move biomass away from the ends of the hopper 156, towards the center. In further instances, the computer 42 uses pressure sensor 36 and related data signal E to determine the biomass 1 at a given coordinate L, D and instruct hydraulic system 170 to move biomass 1.

During operation, computer 42 receives data signal F from as relayed by proximity sensor 38, or data signal H from remote control 46. In certain instances, the remote control 46 may be capable of sending signal H to multiple module builders 100 and should select the appropriate module builder 100 according to the program stored in computer 42. Data signal F notifies computer 42 of approaching machinery, such as a boll buggy, or personnel. In instances data signal F comprises computer 42 instructions for moving the tramper carriage 160 to default location 160A. Moving tramper carriage 160 to default location 160A provides improved access to hopper 156 for deposition of additional biomaterial 1. In certain instances, the proximity sensor 38 data signal F comprise instructions to the computer 42 in order to restart, continue, or complete the autonomous module forming process. In certain instances, the computer 42 restarts the process disclosed herein. Restarting the process allows the computer 42 to determine the coordinate L, D, mass, and volume of recently deposited biomass 1. Further, the computer 42 is configured to determine biomass 1 redistribution within hopper 156 to conform to stored module shape 2. The autonomous module system 10 is configured for adjusting to significant biomass 1 variations due to deposition in hopper 156. Computer 42 comprises stored instructions for redistributing the biomass 1 from significant depositions, or dumps within hopper 156.

In certain instances, computer 42 is configured to generate data signal H′, directed to a remote 46. Data signal H′ is configured to inform an operator 200 of the module shape 2. The data signal H′ may comprise any information suitable for operation of the module builder 100. In certain instances, data signal H′ comprises a module shape 2, such that an operator 200 may direct a biomass 1 unload, dump, or deposit within hopper 156. Without limitation by theory, data signal H′ increases efficiency by showing an operator 200 where additional biomass 1 is needed to form module shape 2. In certain instances, data signal H′ is transmitted to multiple remotes 46 and multiple operators 200, to coordinate harvesting and module building operations. Computer 42 can also selectively transmit data signal H′ to an individual remote 46. Further, the data signal H′ may be received by alternate devices positioned in additional machinery used in the harvesting operation, for example boll buggies, boll strippers, tractors, and the like.

Data signal I notifies computer 42 of a biomass potential overflow at the member 151 or 152. The computer 42 determines the location of the biomass 1 overflow through the use of data signal C from the surface sensor 35. In certain instances, the location is determined by the signals from overflow sensor 39, and related to a longitudinal coordinate L. The computer 42 and transmits data signals J to the hydraulic system 140. In instances, the data signals J comprise instructions to compress the biomass 1 at longitudinal coordinate L. The computer 42 transmits a data signal J to the hydraulic system 170 comprising instructions to compress or move the biomass 1 along the longitudinal axis Lₐ at and around the longitudinal coordinate L of the overflow in order to allow biomass 1 to fall into the module builder chamber 156, thus eliminating the potential loss of biomass 1. Alternatively, computer 42 instructs hydraulic system 170 to execute an emergency process via data signal J to prevent spillage. In instances, an emergency process may comprise a sequence of rapid and/or partial compression strokes of biomass 1 at or near longitudinal coordinate L of the overflow in order to allow biomass 1 to fall into the module builder chamber 156. Alternatively, computer 42 may instruct hydraulic system 170 via data signal J to conduct multiple operations to prevent biomass 1 spillage. Without limitation by theory, an overflow response by computer 42 to signal I is configured to move biomass 1 off the wall members 151, 152 and into the hopper 156, for forming the module shape 2, without loss of biomass 1.

In the forgoing description and discussion, the autonomous module builder has been described having a hydraulic system. As understood by a skilled artisan, any mechanical, electrical, or other system configurable to move and compress biomass may be used. Alternatively, any specific hydraulic component or assembly may be replaced by an alternate component. Examples of suitable replacement components include, without limitation, electrical, electro-magnetic, and mechanical apparatuses.

We claim:

1. An apparatus comprising,
a module builder, having a hydraulic system configured for carrying and extending a tramper into a hopper for compressing biomass to form a module;
a sensor system, having at least one sensor for sensing the position of the tramper; and
a control system, comprising a computer configured to operate the module builder autonomously.

2. The apparatus of claim 1, wherein the sensor system is configured for determining the location of the tramper in the hopper in at least two dimensions.

3. The apparatus of claim 1, wherein the sensor system further comprises at least one pressure sensor.

4. The apparatus of claim 3, wherein pressure sensor is disposed in the hydraulic system.

5. The apparatus of claim 1, wherein the sensor system further comprises a surface sensor for determining the height of biomass in the hopper.

6. The apparatus of claim 1, wherein the sensor system further comprises an overflow sensor for preventing overflow spillage of biomass from the module builder.

7. The apparatus of claim 1, wherein the sensor system further comprises a device configured for receiving a signal or detecting nearby machinery, personnel, or both.

8. The apparatus of claim 1, wherein the sensor system is configured to produce and transmit data signals indicative of the module parameters sensed to the computer system for processing.

9. The apparatus of claim 8, wherein the control system is further configured to operate the hydraulic system according to an algorithm in response to data signals, to form a module having a predetermined shape in response to the data signals.

10. A method for forming a biomass module comprising:
activating a control system having stored instructions after biomass is deposited in a module builder, wherein the control system operates module builder components for:
moving the biomass; and
compressing the biomass autonomously.

11. The method of claim 10, wherein the activating the control system further comprises:
activating a sensor system; and
sensing the position and operation of module builder components.

12. The method of claim 10, wherein activating the control system further comprises instructing the control system to begin operations

13. The method of claim 110 wherein moving the biomass further comprises redistributing the biomass along at least one axis of the module builder.

14. The method of claim 10, compressing the biomass further comprises sensing a characteristic of the biomass module.

15. The method of claim 14, wherein sensing a characteristic of the module comprises determining one property chosen from: volume, mass, quality, position, and combinations thereof.

16. The method of claim 10, wherein moving the biomass further comprises:
operating a component of the module builder to contact the biomass at a first position determined by the control system; and
moving the component of the module builder to a second position determined by the control system, to move the biomass to the second position

17. The method of claim 10, wherein compressing the biomass further comprises
reducing the volume of the biomass; and
forming a biomass module shape.

18. The method of claim 17, wherein forming a biomass module comprises forming a predetermined module shape for increased efficiency and volume of the module.

19. The method of claim 10, wherein forming a biomass module further comprises preventing loss of the biomass from the module builder.

20. The method of claim 19, further comprising sending a signal indicative of the autonomous module builder status to a remote location, wherein the remote location comprises one chosen from an operator of another machine in proximity to the module builder, an operator in another location, a computer system in proximity to the module builder, and a computer system in another location.
